(19) United States
(12) Patent Application Publication
(10) Pub. No.: US 2020/0164598 A1
(43) Pub. Date: May 28, 2020

(54) METHOD FOR JOINING TWO JOIN PARTS USING A PLANAR EMITTER AND A JOINING DEVICE

(71) Applicant: Manz AG, Reutlingen (DE)

(72) Inventors: Benjamin SCHMIEDER, Stuttgart (DE); Dmitrij WALTER, Altdorf (DE); Marvin KIRSCH, Reutlingen (DE); Martin FREUNDT, Esslingen (DE)

(73) Assignee: Manz AG, Reutlingen (DE)

(21) Appl. No.: 16/693,932

(22) Filed: Nov. 25, 2019

(30) Foreign Application Priority Data
Nov. 26, 2018 (DE) 10 2018 129 802.1

(51) Int. Cl. B29C 65/48; C09J 5/06; B29C 65/56

(52) U.S. Cl. CPC B29C 65/4845; C09J 2205/31; B29C 65/565; C09J 5/06

(57) ABSTRACT

A method for joining a first join part, in particular a cover glass, with a second join part, in particular a housing and/or a display layer of a cover glass display assembly, uses a thermosensitive adhesive that is heated indirectly and/or directly by irradiation with light from a light source, in particular with infrared light and/or visible light, for producing the connection. A planar emitter is used as the light source. The method allows for a fast and secure joining of the join parts.

### CROSS-REFERENCE TO RELATED APPLICATIONS

This application claims priority under 35 USC 119 of German Application No. DE 10 2018 129 802.1, filed on Nov. 26, 2018, the disclosure of which is herein incorporated by reference.

### BACKGROUND OF THE INVENTION

The invention relates to a method for joining a first join part, in particular a cover glass, with a second join part, in particular a housing and/or a display layer of a cover glass display assembly, for example of a smartphone, a mobile computer or the like,
wherein the two join parts are joined together by means of a thermosensitive adhesive and
wherein the adhesive is indirectly and/or directly heated by irradiation with light from a light source, in particular with infrared light and/or visible light, for producing the connection.

Smartphones, wearables, mobile computers such as notebooks or tablet computers and the like usually have a cover glass display assembly, which is part of a touch-sensitive display unit, for example. Generally, such cover glass display assemblies can (also) be found in devices for outdoor use and/or in devices for use under water such as (waterproof) watches, trackers and/or measuring devices, in particular tachometers.

In such an assembly, a cover glass is joined with a housing and/or with a display layer of the device in question and in particular glued to it or them. The adhesion runs, in particular, along an edge region of the device in question.

A comparable situation also exists, for example, with regard to rear-view mirrors in motor vehicles, in particular interior rear-view mirrors or exterior rear-view mirrors, in particular with illuminated surfaces, as well as with regard to cameras and the like.

For this purpose, an adhesive is introduced into a joining zone between the cover glass and the housing or the display layer, in particular along its peripheral edges.

In addition to so-called pressure-activated adhesives (PSA), in particular thermoplastic, laser-activated adhesives (LAA) and thermally activated adhesive films with crosslinking constituents (TAA) have increasingly been used as adhesives in recent years. LAAs as well as TAAs both require heat and pressure to form the particular joining properties that are desired.

These thermosensitive adhesives can be heated by irradiation with light, in particular by means of a laser or a laser scanner. To optimize the absorption of the light, a dye layer may be formed in the joining zone. This dye layer is heated by the incident light. The heat is transferred by heat conduction to the adhesive, which is adjacent to the dye layer, causing the adhesive to heat up as well.

Such heating is very time consuming, however. Although, in principle, the adhesive can be heated faster by higher outputs of the laser or higher intensities of the laser light, it may overheat, which may cause, for example, the dye layer to be damaged or destroyed. Furthermore, considerable thermal scattering losses occur as well due to thermal conduction effects.

Furthermore, the thermal scattering losses may also damage components adjacent to the join parts, for example electronic components.

### SUMMARY OF THE INVENTION

The object of the present invention is therefore to provide a method and a device for joining a first join part with a second join part by means of a thermosensitive adhesive, which makes a safe and at the same time rapid joining of the two join parts possible.

The object is achieved by a method for joining a first join part, in particular a cover glass, with a second join part, in particular a housing and/or a display layer of a cover glass display assembly, for example of a smartphone, a mobile computer or the like,
wherein the two join parts are joined together by means of a thermosensitive adhesive and
wherein the adhesive is indirectly and/or directly heated by irradiation with light from a light source, in particular with infrared light and/or visible light, for producing the connection,
wherein a planar emitter is used as the light source.

A planar emitter can be understood as a light source which is configured to irradiate the one or more join parts in a planar manner. A planar emitter can thus be understood as a light source whose light pattern on a surface to be illuminated is—in difference to a usual laser—not or at least substantially not in a punctiform shape. In particular, the size of the light pattern may correspond to the size of the joining region or a joining zone or at least substantially to the size of the joining region or the joining zone or at least a substantial part of the joining region or the joining zone.

By using a planar emitter as the light source, a high light or heat output can be transmitted onto or into the join parts at a low intensity, i.e. despite a low output per unit area. The low intensity reduces the risk of damage to, for example, a dye layer. The dye layer can be heated across a large area, which means that the adhesive can be heated across a large area as well.

Due to the overall higher heat output, the process time can be reduced. Heat losses caused by heat conduction can be minimized. Unlike, for example, when heating an outer side of the assembly with, for example, a heatable joining punch, the heat can be introduced directly into the joining zone. The parts to be joined can thus be treated with care.

While, for example, there is an increased risk of local overheating, especially an overheating of the dye layer, when using a conventional, punctiform-acting laser due to its high intensity of the laser light, such local overheating can be avoided when using a planar emitter. Curved surfaces can be irradiated or radiated through as well without the light reaching or exceeding locally critical intensity limits of the light due to lens effects of the surface.

Furthermore, the light pattern of the light source may be adapted to the respective requirements and properties of the join parts, for example to their shape. Thus, it is conceivable to adapt the light pattern from the light source to the spatial course of the adhesive.

Sensitive elements outside the joining area can be protected against undesired heating.

Due to the planar irradiation, complex and thus costly mechanics as required, for example, for a laser scanner are not necessary.

Consequently, a strip light source may be used as the light source. A strip light source is a light source which produces a substantially rectangular, in particular a striped or line-shaped, light pattern. The light source may be designed as a stationary light. Alternatively or additionally, the light source may be designed to run across an area to be illuminated. The light source may be designed to radiate a predefined amount of energy onto the area to be illuminated. For this purpose, the light source may, for example, if the adhesive is an LAA, also be configured to vary its irradiation intensity and/or its speed of travel when passing over the area to be illuminated, in particular as a function of the respective (local) width of the area.

Particularly in the case of smartphones, tablet computers and the like, the cover glass display assemblies to be processed are often rectangular or at least substantially rectangular. Thus, if the light source is designed as a strip light source, the light source or the light pattern of the light source may be focused into an area along one of the edges of the join parts. If the light source has several strip light sources, several of the edges may be covered at the same time.

It is conceivable for the first join part, the second join part and/or their joining zones to be irradiated with light having a light intensity, in particular measured as pulse peak intensity, of 10 W/mm² at the most, preferably 1 W/mm² at the most. As a result, overheating can be avoided in conventional cover glass display assemblies and in the dye layers commonly used for them. In particular, the light intensity may, compared to a punctiform light source, be reduced by using the planar irradiation, for example below a material-specific process limit. Alternatively or additionally, the speed of the process may be increased. In general, it is conceivable that the light intensity is selected on the basis of the material of one or more light-absorbing layers, in particular on the basis of the dye layer.

In particular, a thermoplastic, a substance with crosslinking constituents and/or an adhesive having such a substance may be used as adhesive. The thermoplastic may be, for example, an LAA. In particular, the thermoplastic may be meltable several times. The substance with a crosslinking composition may be a TAA. In particular, the substance with a crosslinking composition may be activated once, for example, with increased heat. Such adhesives require, inter alia, controlled or controllable heat or temperature conditions that can be met when using the method according to the invention.

Since the method according to the invention is able to avoid local overheating, a light-absorbing or at least partially light-absorbing dye layer can be irradiated, in particular for the purpose of heating the adhesive. The dye layer is able to improve the absorption of the incident light, in particular within the joining zone. The dye layer may be an ink, comprise an ink and/or be made by means of an ink. The dye layer may be nontransparent to visible light or at least substantially nontransparent. This results in an additional visual protection so that the layers located under the dye layer are not visible from the outside or covered by the dye layer. Alternatively or additionally, the dye layer may, for example, in a cover glass display assembly to be manufactured of a device such as a smartphone, optically hide one or more areas that should not be visible to a user of the device.

It is also conceivable that at least two individual light sources, for example at least two LEDs, are used as the light source. Thus, a powerful planar emitter can be produced from inexpensive individual components. It is also conceivable that at least one individual light source is designed as an infrared emitter, in particular with a focusing device, and/or comprises such an emitter. Alternatively or additionally, at least one individual light source may be configured as a laser and/or comprise a laser, in particular with a low beam power and preferably with a beam-shaping device.

The light source used may be a matrix light source, in particular a vertical cavity surface-emitting laser (VCSEL) array. VCSEL arrays comprise a plurality of planar-emitting individual light sources arranged in matrix form. These make it possible to generate a particularly homogeneous, planar light pattern in an inexpensive manner. It is possible to generate high light outputs, in particular in the range of 100 W-10 kW.

VCSEL arrays also make it possible to control the individual light sources of the array separately from each other. Thus, a light distribution adapted to the shape of the joining zone or to the adhesive may be generated during production, i.e. within the light source.

The light may be masked along its beam path by a masking device. As a result, the light pattern may be adapted more precisely to the shape or the course of the joining zone. Sensitive areas of the assembly or adjacent elements may be shaded and thus protected.

In particular, the method may provide that the size and/or the position of a masking window of the masking device are adjusted. For this purpose, the masking device may be configured to be variable in shape. In particular, the masking device may consist of four slit masks, in particular rectangular slits, arranged so as to be displaceable relative to each other. By means of such a masking device, a rectangle masking may take place in adjustable dimensions. Alternatively or additionally, radii or curvature masking elements, in particular those formed for a specific application, may be provided for masking one or more curvilinear regions.

Alternatively or additionally, the light source may also be movably arranged, in particular relative to the first and/or second join part.

It is also conceivable that the beam path of the light is shaped and/or directed by a lens assembly and/or by a mirror device. In particular if the light source has a plurality of individual light sources, the individual light sources may be arranged in a spatially distributed manner and still produce a continuous, in particular seamless, light pattern.

It is therefore particularly advantageous if at least one, preferably each, individual light source is assigned a part and/or a portion of the lens assembly and/or the mirror assembly. This makes it possible to separately control and/or shape the beam path of the light emitted by the at least one or by each individual light source.

In a variant of the method according to the invention, the light source is operated during the joining with at least two different power levels. Alternatively or additionally, the duty cycle of the light source and/or—especially in a pulse width modulated operation of the light source—their pulse width may be varied for example.

By operating the light source with at least two different power levels, it is possible to use the same light source for several process phases of the joining process. As a result, different types of adhesives may be used as well. If, for example, the adhesive is a TAA, then the joining process can take place in two different stages. In a first heating phase with, for example, 1 W/mm² over a period of less than one second, a specific temperature level can be set, and in a second heating phase in a period of one or more seconds, the adhesive can be heated to a higher temperature level. Subsequently, in a post-heating phase, the temperature in the joining zone may be kept approximately at the same level by irradiating the zone with a reduced power.

At least one individual light source may be operated with a higher individual light power than at least one other individual light source. For this purpose, the light source may be configured to produce an adjustable light distribution. This also makes it possible to adapt the light distribution to the shape of the adhesive material or the joining zone to be heated beforehand. Individual light sources arranged in a central region of the light source may, for example, be operated with a lower power to obtain a light distribution which irradiates substantially along the edge regions of the join parts and/or which takes component-specific heat outflows into consideration, for example during a longer joining process.

In order to achieve a permanent connection, the two join parts may be pressed against each other before, during and/or after the irradiation with light, in particular with a joining punch, particularly preferably with a deformable joining punch.

For this purpose, the joining device used may have, in particular, a deformable, joining punch. The joining punch may press against a join part, for example against the first join part, while the other, for example, the second, join part is mounted on a workpiece carrier. The workpiece carrier may be deformable. In particular, the workpiece carrier may be configured to adapt to the shape of the workpiece it carries, in particular the second join part. The joining device may have, for example, a plurality of joining punches for this purpose. Each join part may be pressed against the respective other join part by a joining punch assigned to it, for example. The joining punches may be configured to be adaptable in their shape and/or in the distribution of the pressure applied by them onto the respective join parts to be joined.

Furthermore, included in the context of the invention is a joining device, in particular a device for carrying out the method according to the invention, for joining a first join part, in particular a cover glass, with a second join part, in particular a housing and/or a display layer of a cover glass display assembly, for example of a smartphone, a wearable, a mobile computer or the like, by means of a thermosensitive adhesive, with a light source for the direct and/or indirect heating of the adhesive by irradiating the adhesive with light, in particular with infrared and/or visible light, wherein the light source is formed as a planar emitter, in particular as a VCSEL array.

The joining device may have, in particular a deformable, joining punch for pressing the first join part and the second join part against each other.

Such a deformable joining punch can be obtained, in particular, when the joining punch has at least one force-receiving part which can be acted upon by a contact force F and at least two pressing parts for putting pressure on the first join part, wherein the at least two pressing parts are tiltably arranged and/or configured on the joining punch independently of one another relative to the force-receiving part.

Additional features and advantages of the invention may be found in the following detailed description of the embodiments of the invention, on the basis of the figures of the drawing, which show details essential to the invention, and in the claims.

The features shown in the drawing are shown in such a way that the features of the invention can be made clearly visible. The different features may each be realized in variants of the invention either in isolation or together in any desired combinations.

### BRIEF DESCRIPTION OF THE EMBODIMENTS

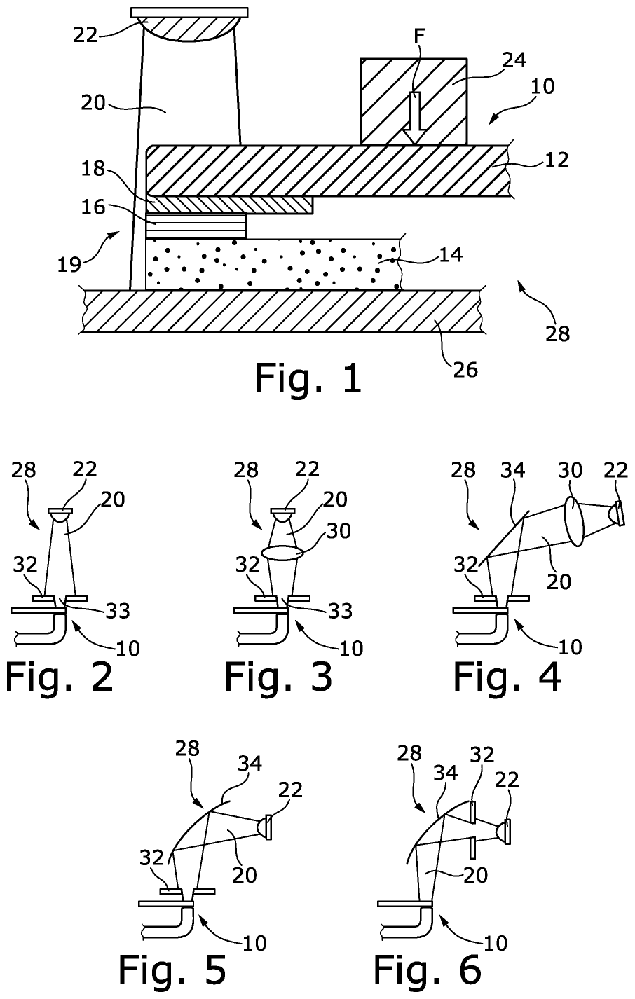

FIG. 1 provides a schematic representation of a joining device with an assembly with two join parts to be joined as a cross-sectional view;

FIGS. 2 to 6 provide schematic representations of joining devices with differently configured beam paths;

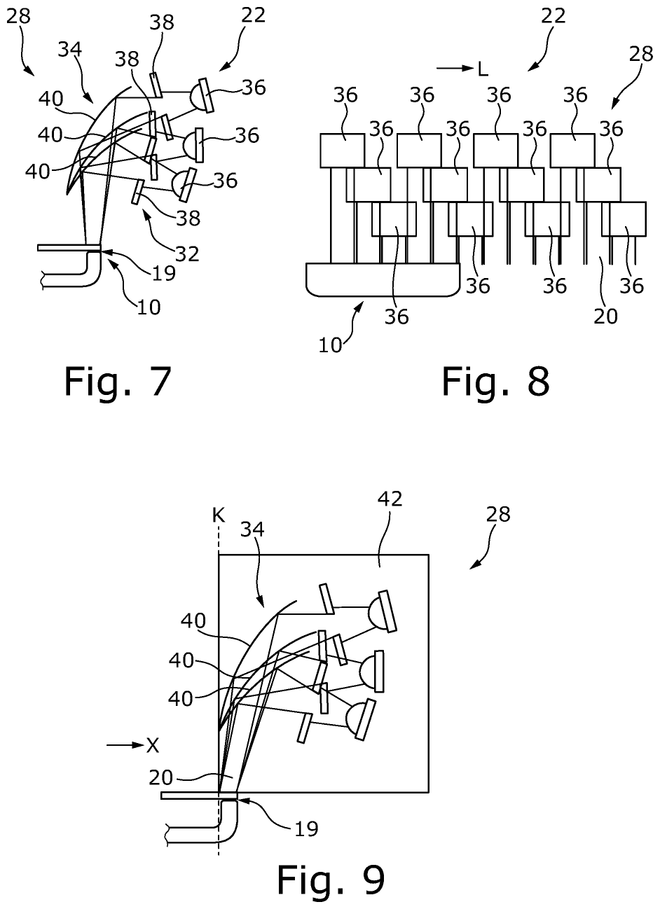

FIGS. 7 and 8 provide schematic side and front views of a joining device with a matrix light source;

FIG. 9 provides a schematic side view of a further improved embodiment of a joining device;

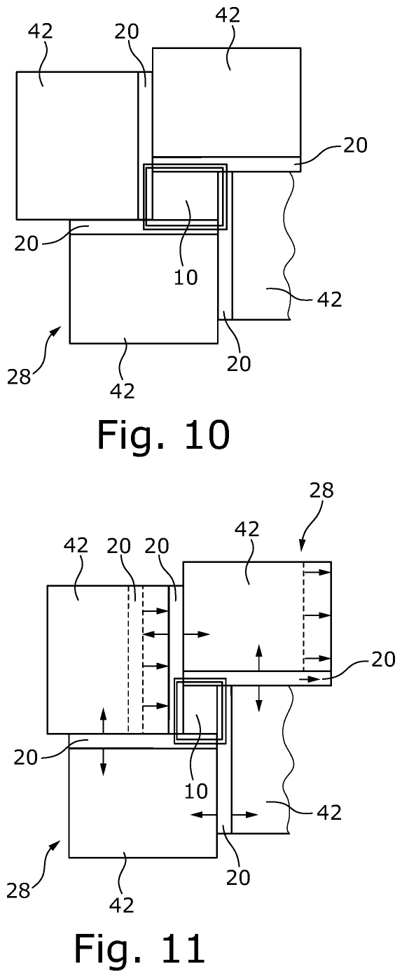

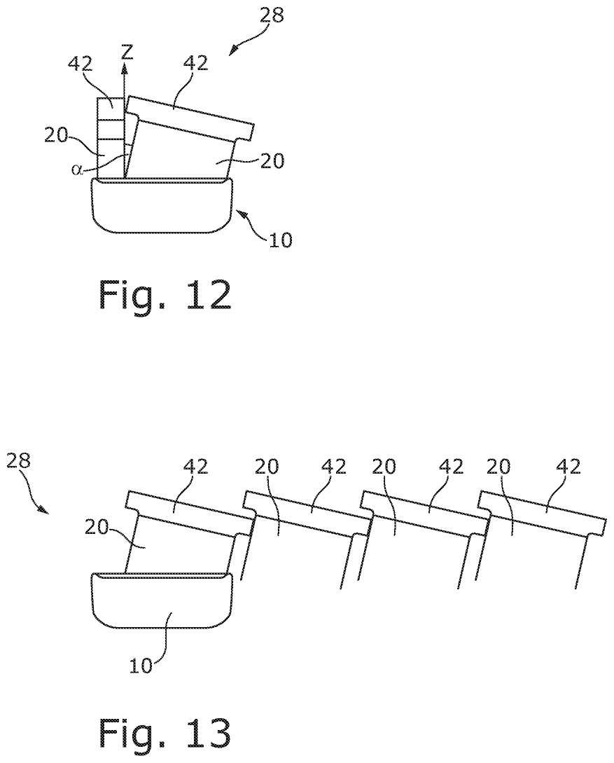

FIGS. 10 and 11 provide schematic plan views of a joining device which may be adapted to the shape of the join parts to be joined;

FIGS. 12 and 13 provide a schematic partial side view and a flat pattern view on a further joining device that is adaptable to the shape of the join parts to be joined;

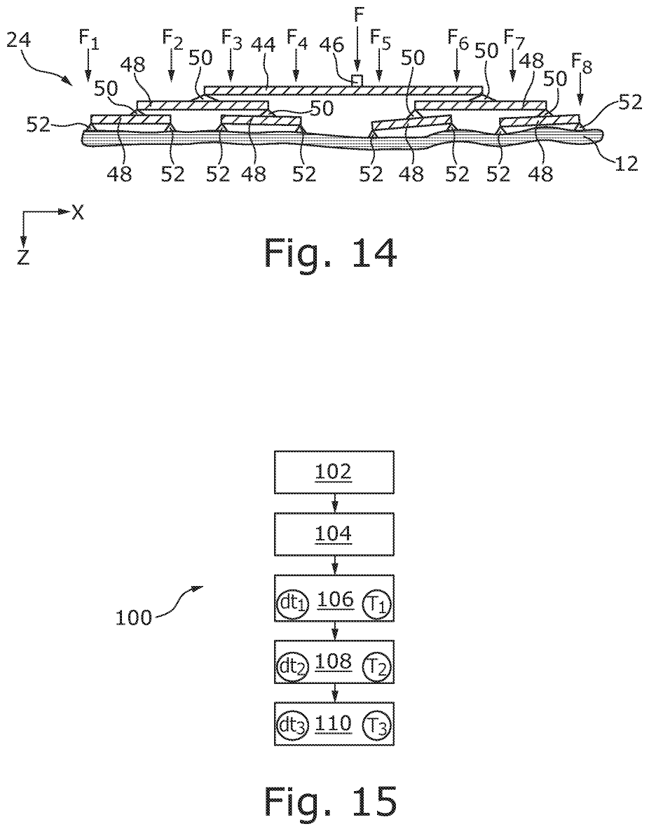

FIG. 14 provides a schematic cross-sectional view of a joining punch of a joining device and

FIG. 15 shows a schematic representation of the method according to the invention.

### DETAILED DESCRIPTION OF THE EMBODIMENTS

FIG. 1 shows an assembly 10 with a first join part 12 and a second join part 14. Assembly 10 is a cover glass display assembly of a smartphone. In particular, the first join part 12 is a cover glass of the smartphone. The second join part 14 is part of a housing of the smartphone. The two join parts 12, 14 are to be joined to each other by an adhesive 16. The adhesive 16 is a TAA.

A dye layer 18 is applied to the underside of the first join part 12 and adjacent to the adhesive 16. The adhesive 16 and the dye layer 18 are thus located in a joining zone 19.

While the first join part 12 is substantially transparent to light in the wavelength ranges of visible light and near infrared, in particular in the range 800-1100 nm, the dye layer 18 is nontransparent in these wavelength ranges. It thus absorbs light from these wavelength ranges.

Light 20, in particular in the aforementioned wavelength ranges, may be generated by a light source 22 designed as a strip light source and irradiated in the direction of the assembly 10. The light source 22 in particular generates a strip-shaped light. For this purpose, the light source 22 is designed as a VCSEL array. The light output it generates as well as the radiated light distribution may be adjusted.

It can be seen that in order to join the two join parts 12, 14, the light 20 passes through the first join part 12 and is absorbed by the dye layer 18. The dye layer 18 heats up and thus the adhesive 16 heats up as well. Alternatively, it is also conceivable that the dye layer 18 is dispensed with. In such a case, it is advantageous if at least one layer below the dye layer 18, for example the adhesive 16, is configured to absorb the light 20.

By means of a joining punch 24, the first join part 12 may be pressed against the second join part 14 with a contact force F. To do so, the second join part 14 is fixed on a workpiece carrier 26. The workpiece carrier 26 may be arranged in a stationary manner. The joining punch 24 is, in particular, configured to uniformly apply the contact force F across a wide area, i.e. across a larger area of the first join part 12.

The light source 22, the joining punch 24, as well as the workpiece carrier 26 are components of a joining device 28. Apart from the parts mentioned, the joining device 28 also comprises further parts, which are not shown in FIG. 1 for simplification reasons. In particular, the joining device 28 comprises a handling device with which the join parts 12, 14 are positioned, and with which they are, in particular, inserted into the joining device 28 for processing and from which they can be removed after the completion of a joining operation. The joining device 28 also has a controller for controlling the different components. The control unit is, in particular, configured to carry out the method according to the invention by means of the joining device 28. The joining device 28 may, for example, also have a masking device for fine-tuning of the exposure. It may have one or more, in particular optical, sensor units for detecting a temperature, for example the temperature of one or both join parts. At least one of the sensor units may be reflected into the beam path of the light 20. Alternatively or additionally, at least one of the sensor units may be arranged along an optical path deviating from the beam path of the light 20. For example, the at least one sensor unit may monitor the joining region from a viewing position located outside the beam path of the light 20. The joining device may also comprise a motor and/or a sensor unit for the, in particular active, alignment of the masking device and/or the light source 22 relative to the first and/or second join part 12, 14.

FIG. 2 to FIG. 6 now show different embodiments of joining devices 28. The joining devices 28 differ, in particular, by the respective course of the beam paths of the light 20.

In the embodiment shown in FIG. 2, the light 20 is guided rectilinearly from the light source 22 to the assembly 10 to be exposed.

For shading areas to be protected of the assembly 10 or, respectively, of the smartphone, a masking device 32 is arranged in the beam path of the light 20, in particular close to the assembly 10. The masking device 32 has a masking window 33 through which light 20 can pass. The masking window 33 may have a slit-like design and/or have a varying slit width, in particular transversely to the image plane of FIG. 2.

In the embodiment according to FIG. 3, which largely corresponds to the embodiment according to FIG. 2, a lens assembly 30 is additionally arranged in the beam path of the light 20 in order to reduce scattering losses and to protect components of the smartphone or the assembly 10 which are not to be heated. The lens assembly 30 corresponds in its cross section to a convex lens. It has, just as the light source 22, an elongated shape which is transverse to the image plane of FIG. 3. It may be configured to displace the light 20, in particular along a longitudinal and/or a transverse direction, in order, for example, to avoid collisions in the installation space of different components, in particular of the joining device 28.

In a preferred embodiment of the invention, a glass pane which is transparent, in particular for the light 20 (not shown in FIGS. 1 to 9 for simplification reasons), may furthermore be placed in the beam path of the light 20. The glass pane makes it possible to form a closed contour around the joining punch 24. Thus, the light source 22 can already be moved to another assembly 10 to be joined, for example, in this or another joining device 28, so that it can illuminate the other assembly 10 while the joining punch 24 still remains with the first assembly 10 for a remaining pressure application period. Thus, for example, the utilization of the light source 22 can be increased, in particular during cooling processes of the join parts 12, 14.

The joining device 28 according to FIG. 4 is essentially configured in accordance with the joining device 28 shown in FIG. 3. This joining device 28, however, additionally comprises a mirror device 34 with which the light beam 20 is guided at an angle. Thus, the light source 22 can be positioned substantially at will, for example, depending on space requirements. The mirror device 34 is arranged between the lens assembly 30 and the masking device 32.

In the embodiment of the joining device 28 shown in FIG. 5, a lens assembly 30 (FIG. 4) can be dispensed with since the mirror device 34 is designed as a curved mirror. The mirror device 34 thus assumes both the directing and the beam-forming functions.

In the joining device 28 shown in FIG. 6, the masking device 32 is located between the light source 22 and the mirror device 34. This arrangement of the masking device 32 provides greater clearance in an area of an upper surface of the assembly 10. This additional clearance can be used, for example, to arrange the joining punch 24 (FIG. 1).

FIGS. 7 and 8 show schematic views of a further embodiment of a joining device 28, but FIGS. 7 and 8 only show the parts of the joining device 28 that are important for explanatory purposes. FIG. 7 shows a schematic side view of the joining device 28, and FIG. 8 shows a schematic front view of the light source 22 of the joining device 28.

In this embodiment, the light source 22 is formed from a plurality of individual light sources 36. The individual light sources 36 are arranged at regular intervals and, in particular, distributed across a wide area. As a result of this arrangement, it is possible, as can be seen in FIG. 8, to produce a virtually seamless light pattern with a largely homogeneous light distribution of the light 20.

In order to make this arrangement of the individual light sources 36 possible in terms of space, the masking device 32 and the mirror device 34 are each constructed from a plurality of individual elements. In particular, each individual light source 36 is assigned a single mask 38 and a single mirror surface 40 or respectively arranged in the respective beam path of the respective individual light source 36. Each individual mask 38 thus delimits or respectively masks the beam path of the individual light source 36 assigned to it. In this exemplary embodiment, the individual masks 38 are each designed in two parts so that a slit-shaped masking window is formed between their individual mask parts. However, it is also conceivable to form the individual masks 38 in one piece with a, in particular slit-shaped, preferably centered, masking window.

The individual elements 38, 40, in particular, make it possible that all the individual light sources 36 irradiate into the assembly 10 or into the joining zone 19 virtually without any scattering losses.

FIG. 8 shows that the light source 22 protrudes beyond the assembly 10 along its longitudinal direction L. To adapt the light distribution to the join parts 12, 14 of the assembly 10 to be joined, the individual light sources 36 which protrude beyond the assembly 10 in the longitudinal direction L may be operated at a lower power or generally at a different power than the single light sources 36 that are arranged directly above the assembly 10.

A further development of the joining device 28 according to FIG. 7 or FIG. 8 is shown in FIG. 9.

It can be seen, in particular, that the mirror device 34 with its individual mirror surfaces 40 extends along a horizontal direction x at most to an edge K of the joining zone 19. In other words, the mirror device 34 does not protrude beyond the edge K. To this purpose, the individual mirror surfaces 40 are suitably curved, in particular more curved in comparison with FIG. 7.

As will be explained in more detail below, a plurality of such arrangements or joining devices 28 can be positioned side by side and collision free as partial joining devices 42 and be used as a joining device 28 adaptable to different assemblies 10 (FIG. 1) to be processed of, for example, different smartphones.

Consequently, FIGS. 10 and 11 show such an adaptable embodiment of a joining device 28 and its use for two differently sized assemblies 10.

It can be seen that the assemblies 10 to be processed according to FIG. 10 or FIG. 11 are each rectangular or at least substantially rectangular.

The joining device 28 has four partial joining devices 42, which respectively correspond to the partial joining device 42 according to FIG. 9, in particular with the light source 22, the masking device 32 and the mirror unit 34. The joining device 28 can thus produce light 20 with a light pattern consisting of four strips.

Each partial joining device 42 and thus each strip of light 20 can be displaced in one direction each. As indicated in FIG. 11 by means of double arrows, these directions are each oriented perpendicular to each other.

Because the individual mirror surfaces 40 (FIG. 9) extend as far as the respective edge K (FIG. 9), the light 20 with its four strips outshines in each position of the partial joining devices 42 an (at least almost) seamless, essentially rectangular annular surface.

Thus, by moving the partial joining devices 42 and thus the strips of light 20, the size and shape of the generated light pattern can be adapted to the particular assembly 10 to be processed.

The embodiment of a joining device 28 illustrated in FIGS. 12 and 13 also allows for such an adaptability with an (almost) seamless irradiation of a substantially rectangular annular surface.

This joining device 28 in turn has four partial joining devices 42, which in turn are arranged to be displaceable, in particular collision free, in parallel or at least substantially parallel to the upper side of an assembly 10 to be joined.

FIG. 12 shows a schematic partial side view of the joining device 28. For simplicity, only two of the four partial joining devices 28 are shown in FIG. 12. FIG. 13 shows a schematic flat pattern view of the joining device 28 with the four partial joining devices 42 shown here in the flat pattern form.

Each of the partial joining devices 42 is in turn configured as a strip light source and projects light 20 onto the assembly 10. In the assembled state, i.e. in the original state that the flat pattern view shown in FIG. 13 is based on, the partial joining devices 42 are arranged perpendicular to each other according to a plan view.

In addition, as shown particularly in FIG. 12, the partial joining devices 28 are tilted in this embodiment with a tilting angle α against the direction z, so that a collision with another partial joining device 28 can be avoided when one of the partial joining devices 28 is displaced.

As can be seen as well, for example, in FIG. 12, the inclination by the inclination angle α also makes it possible for the light 20 to outshine an (at least almost) seamless surface.

In this joining device 28, the mirrors within the partial joining devices can be dispensed with. Intensity gradients of the light 20 which may occur, in particular at the edges of the respective beam paths, may be avoided or removed by suitable masking devices 32 (see FIG. 2 for example).

The joining device 28 may, in particular in the embodiments described above, have at least one, in particular deformable, joining punch 24 (FIG. 1).

Such a deformable joining punch 24 is shown in FIG. 14 in a schematic representation.

The joining punch 24 has a force-receiving part 44 which can be acted upon by the contact force F along a direction z orthogonal to the direction x. The force-receiving part 44 is formed as a bar and has approximately in the middle a force-receiving point 46 onto which the contact force F is applied in a joining operation.

Below the force-receiving part 44, a plurality of load-guiding parts 48 is hierarchically arranged in several planes, in this case in two planes. The load-guiding parts 48 are also designed as bars.

The load-guiding parts 48 are tiltably arranged via hinge parts 50 on the respective element located above them, i.e. on a load-guiding part 48 or on the force-receiving part 44 located above them. They are thus tiltably arranged relative to the force-receiving part 44 on the joining punch 24.

Two pressing parts 52 are arranged on each of the load-guiding parts 48 in the lowest plane. In the situation shown in FIG. 14, the joining punch 28 contacts with the pressing parts 52 the first join part 12 which is to be pressed against the second join part 14 (FIG. 1).

Due to the tiltable arrangements of the load-guiding parts 48, the pressing parts 52 are tiltably arranged on the joining punch 24, at least independently of the pressing parts 52 that are arranged on the respective other load-guiding parts 48, relative to the force-receiving part 44. It is conceivable that, as an alternative or in addition, the pressing parts 52 are directly tiltably arranged, in particular mounted, on the respective load-guiding parts 48 of the lowest plane.

This capacity to tilt causes the joining punch 24 to be deformable. It may, when the two join parts 12, 14 are pressed against each other, adapt in particular to the surface geometry of the first join part 12, which may have changed itself and may be irregular under certain circumstances due to the joining process, and thus cause a more evenly distributed or adjustably distributed introduction of the contact force F or, respectively, of generated contact pressures; to this purpose, the distributions of the contact force F or of the contact pressures may be adjusted in particular by making adaptations to the shape and/or dimensions of the components of the joining punch 24.

For clarity reasons, the deformations of the first join part 12 during the joining process are significantly enlarged in FIG. 14.

It can be seen that when the force-receiving part 44 is acted upon by the contact force F, the pressing parts 52 press with partial forces F1 to F8 onto the first join part 12 at their respective contact points or transfer the respective partial forces F1 to F8 to it.

As a result of the tiltable arrangements of the load-guiding parts 48, the load-guiding parts 48 can tilt in such a way that all the pressing parts 52 rest on the first join part 12 despite its deformations. Thus, it is possible to apply a uniform force onto the first join part 12.

FIG. 15 will now be used to explain the steps of the method 100 according to the invention in more detail below. To this purpose, reference is made once again to the reference numerals of the figures described above to identify the elements of the joining device used.

In a first step 102, the assembly 10 of the joining device 28 to be processed, which, for example, has the embodiment according to FIGS. 10 and 11, is provided. In particular, the join parts 12, 14 together with the (thermosensitive) adhesive 16 are introduced into the joining device 28 and locked in position.

The required contact pressure F or the required pressure distribution is built up in this step 102 by means of the joining punch 24.

Then, in a step 104, the masking device 32 is set up, in particular adjusted; in particular, the size of its masking window 33 is adapted to the assembly 10 to be processed. Alternatively or additionally, the masking device 32 may also be set up in advance, in particular during an initial setup step.

Furthermore, the light distribution or the emission characteristic of the light source 22 is adjusted. The adjustments of the masking device 32 and/or the light distribution of the light source 22 may be carried out, for example, analogously to the procedure illustrated in FIGS. 10 and 11. In particular, one or more partial joining devices 42 may be displaced for this purpose.

If the adhesive 16 is an LAA or a TAA, it must first be heated to a wetting temperature T1 or up to a melting temperature, and this wetting temperature T1 should be kept at least approximately over a wetting time dt1. At this wetting temperature T1, the adhesive initially wets the two join parts 12, 14 adjacent to it.

To ensure that the chemical reactions required for the establishment of the connection properties are triggered or take place in such an adhesive 16 designed as a TAA, such an adhesive 16 must subsequently be heated to a reaction temperature T2. The reaction temperature T2 must then at least approximately be held over a reaction time dt2. Then, the adhesive 16 is cooled over a cooling time dt3 until it reaches a removal temperature T3.

The temperatures T1, T2, T3 and the times dt1, dt2, dt3 are selected, in particular, depending on the materials used, in particular the adhesive 16 and/or the join parts 12, 14.

In a step 106, therefore, the light source 22 is operated for a short time with high power or intensity, causing the adhesive 16 to be heated indirectly by irradiating the dye layer 18 with light 20 until the adhesive 16 reaches the wetting temperature T1. An intensity of about 1 W/mm² is generated, for example. After reaching the wetting temperature T1, the power or intensity of the light source 22 is temporarily reduced in order to at least approximately maintain the wetting temperature T1 over the wetting time dt1.

If the adhesive 16 is a TAA, the light source 22 is reused during a next step 108 until the adhesive 16 reaches the reaction temperature T2. In particular, the light source 22 can be operated with increased power. This increased power or intensity is, in turn, used for a comparatively short period of time. Then, the power or intensity of the light source 22 is again reduced to at least approximately keep the reaction temperature T2 over the reaction time dt2. Meanwhile, the two join parts 12, 14 are still pressed against each other or, respectively, the contact force F is still maintained by means of the joining punch 24.

If the adhesive 16 is a thermoplastic, for example a LAA, step 108 may be omitted and the method continued immediately at step 110.

Finally, in a last step 110 the temperature is reduced from the reaction temperature T2 to the removal temperature T3 over the cooling time dt3. The assembly 10 may then be removed from the joining device 28 and processed further, for example.

In a variant of the method, a plurality of method steps, in particular method steps 106 and 108, are not performed on the same joining device 28 and/or at least not by means of the same light source 22, but a plurality of joining devices 28 and/or different light sources 22 are used. A laser or a laser scanner may be used, for example, instead of a light source 22 in the form of a planar emitter for the heating to the temperatures T1 and/or T2.

It is also conceivable in order to maintain a temperature, in particular the wetting temperature T1 and/or the reaction temperature T2, to provide a thermal insulation and/or to supply thermal energy from the outside, for example via the workpiece carrier 26 and/or the joining punch 24 instead of or in addition to a reduced power supply by the light source 22.

Furthermore, a joining device 28 is conceivable which is adapted to join more than one assembly 10 or more than one pair of join parts 12, 14 to be joined together. In connection with such a joining device 28, a variant of the method 100 according to the invention is to join several assemblies 10 or pairs of join parts 12, 14 to be joined together simultaneously or alternately.

### REFERENCE CHARACTERS

10 Assembly
12 Join part
14 Join part
16 Adhesive
18 Dye layer
19 Joining zone
20 Light
22 Light source
24 Joining punch
26 Workpiece carrier
28 Joining device
30 Lens assembly
32 Masking device
33 Masking window
34 Mirror device
36 Single light source
40 Single mirror surface
42 Partial joining device
44 Force-receiving part
46 Force-receiving point
48 Load-guiding part
50 Hinge part
52 Pressing part
100 Method
102 Step
104 Step
106 Step
108 Step
110 Step
dt1 Wetting time
dt2 Reaction time
dt3 Cooling time
F Contact force
F1 to F11 Partial force
K Edge
T1 Wetting temperature
T2 Reaction temperature
T3 Removal temperature
x Direction
z Direction
α Tilting angle

What is claimed is:

1. A method for joining a first join part with a second join part, comprising:
joining the two join parts together by means of a thermosensitive adhesive and
heating the adhesive indirectly and/or directly by irradiation with light from a light source in the form of a planar emitter, for producing a connection between the two join parts.

2. The method according to claim 1, wherein a strip light source is used as the light source.

3. The method according to claim 1, wherein the first join part, the second join part and/or their joining zone is irradiated with light with a light intensity measured as pulse peak intensity, of maximally 10 W/mm².

4. The method according to claim 1, wherein the adhesive is selected from the group consisting of a thermoplastic, a substance with crosslinking constituents and an adhesive comprising a substance with crosslinking constituents.

5. The method according to claim 1, wherein a dye layer that is configured to at least partially absorb light is applied adjacent the thermosensitive adhesive, the dye layer being irradiated by the light source in the step of heating the adhesive.

6. The method according to claim 1, wherein the light source comprises at least two individual light sources.

7. The method according to claim 1, wherein the light source comprises a matrix light source.

8. The method according to claim 1, further comprising the step of masking the light with a masking device along a beam path of the light.

9. The method according to claim 8, further comprising adjusting a size and/or position of a masking window of the masking device.

10. The method according to claim 1, wherein a beam path of the light is formed and/or directed by a lens assembly and/or by a mirror device.

11. The method according to claim 6, wherein at least one individual light source is assigned to each join part.

12. The method according to claim 1, wherein the light source is operated with at least two different power levels during the step of heating.

13. The method according to claim 6, wherein at least one of the individual light sources is operated with a higher individual light power than at least one other of the individual light sources.

14. The method according to claim 1, wherein the two join parts are pressed against each other before, during and/or after the irradiation with light with a joining punch.

15. A joining device configured for joining a first join part with a second join part by means of a thermosensitive adhesive, comprising a light source configured for directly and/or indirectly heating the adhesive by irradiating the adhesive with infrared and/or visible light, wherein the light source is designed as a planar emitter.

16. The joining device according to claim 15, wherein the joining device further comprises a deformable, joining punch for pressing the two join parts against each other.

17. The joining device according to claim 16, wherein the joining punch has
at least one force-receiving part which is configured to be acted upon by a contact force (F), and
and at least two pressing parts for putting pressure on the first join part,
wherein the at least two pressing parts are tiltably arranged and/or configured on the joining punch independently of one another relative to the force-receiving part.

18. The method according to claim 1, wherein the first join part is a cover glass and the second join part is a housing and/or a display layer of a cover glass display assembly.

19. The method according to claim 1, wherein the light is infrared light and/or visible light.
